(19) United States
(12) Patent Application Publication
(10) Pub. No.: US 2019/0247258 A1
(43) Pub. Date: Aug. 15, 2019

(54) PATIENT LIFT HAVING AUTOMATIC FOLDING AND UNFOLDING APPARATUS

(71) Applicant: APEX HEALTH CARE MFG., INC., CHIAYI COUNTY (TW)

(72) Inventor: CHI-TZUNG HUANG, CHIAYI COUNTY (TW)

(21) Appl. No.: 15/892,736

(22) Filed: Feb. 9, 2018

(51) Int. Cl. A61G 7/10

(52) U.S. Cl. CPC A61G 7/1074; A61G 2203/12; A61G 7/1046; A61G 7/1017

(57) ABSTRACT

A patient lift having automatic folding and unfolding apparatus is disclosed. It comprises a base having a dynamic mechanism, two supporting legs connected to the dynamic mechanism for opening and closing actions, a main frame disposed on the base, a lifting arm pivotally connected to an end of the main frame, a lifting device disposed between the main frame and the lifting arm, and an automatic controlling module correspondingly connected to the dynamic mechanism and the lifting device to spread or close the two supporting legs and to elevate or reset the lifting arm.

### BACKGROUND OF THE INVENTION

### 1. Field of the Invention

The present invention relates to a patient lift having automatic folding and unfolding apparatus which is convenient in use.

### 2. Description of Related Art

In general, medical facilities are usually equipped with patient lifts for transportation of heavily ill or disabled patients to make it convenient in transporting patients to a predetermined location by medical staffs.

A traditional patient lift has two lateral legs extended from a base to connect to a middle crossbar and a back crossbar and two pedals disposed in a back region to control an inward closing action or a spreading action of the two lateral legs by pedaling the pedals left and right repeatedly. To transport the patient lift to pass through a ward door and place the two lateral legs of the patient lift under a medical bed successfully, a medical staff has to close the two lateral legs of the patient lift inward by pedaling the pedals left and right repeatedly. A patient to be transported is then moved away from the hospital bed by a hanger and a hanging bag hooked on the hanger of the patient lift and then transported out of the ward door. When moving the patient from the patient lift into the hospital bed, the medical staff has to close the lateral legs inward and then support the patient lying in the hanging bag by hands to lay the patient on the hospital bed stably.

However, the traditional patient lift described above is operated by manpower including operating the hanger manually, and pedaling the pedals to spread or close the lateral legs. These manual operations are time-consuming and laborious and causes heavily physical burden on the medical staffs or the operators.

### SUMMARY OF THE INVENTION

The present invention relates to a patient lift having automatic folding and unfolding apparatus which is convenient in use.

The patient lift having automatic folding and unfolding apparatus comprises a base, two supporting legs, a main frame, a lifting arm, a lifting device and an automatic controlling module.

The base has a dynamic mechanism, and the dynamic mechanism is connected to the two supporting legs for driving the two supporting legs to spread or close. The main frame is disposed on the base, and the lifting arm is pivotally connected to an end of the main frame. The lifting device is disposed between the main frame and the lifting arm. The automatic controlling module is correspondingly connected to the dynamic mechanism and the lifting device and further provided with an initiation unit to initiate the dynamic mechanism for spreading the two supporting legs and uplifting the lifting arm.

According to an embodiment of the present invention, the automatic controlling module comprises a first micro-switch unit for controlling the lifting device to uplift or lower the lifting arm.

According to an embodiment of the present invention, the automatic controlling module comprises a second micro-switch unit for controlling the dynamic mechanism to spread or close the two supporting legs.

According to an embodiment of the present invention, the automatic controlling module comprises a reset unit for initiating and controlling the dynamic mechanism to foldably reset the two supporting legs and downwardly reset the lifting arm.

According to an embodiment of the present invention, the automatic controlling module is disposed on the main frame.

According to an embodiment of the present invention, the patient lift further comprises an external remote controlling module for connectibly controlling the dynamic mechanism and the lifting device to spread or close the two supporting legs and to uplift or lower the lifting arm.

According to an embodiment of the present invention, the remote controlling module connectibly controls the two supporting legs and the lifting arm in a wired or a wireless manner.

### BRIEF DESCRIPTION OF THE DRAWINGS

FIG. 1 is a stereogram showing a patient lift having automatic folding and unfolding apparatus of the present invention;

FIG. 2 is a perspective stereogram showing a base of the present invention;

FIG. 3 is a schematic diagram showing an automatic controlling module of the present invention;

FIG. 4 is a stereogram showing a spreading state and an uplifting state of the present invention;

FIG. 5 is a schematic diagram showing transition of a lifting arm from an uplifting state to a lowering state of the present invention;

FIG. 6 is a front view showing a spreading state of two supporting legs of the present invention;

FIG. 7 is a front view showing a closed state of two supporting legs of the present invention.

### DETAILED DESCRIPTION OF THE PREFERRED EMBODIMENT

To provide a thorough understanding, the purpose and advantages of the present invention will be described in detail with reference to the accompanying drawings.

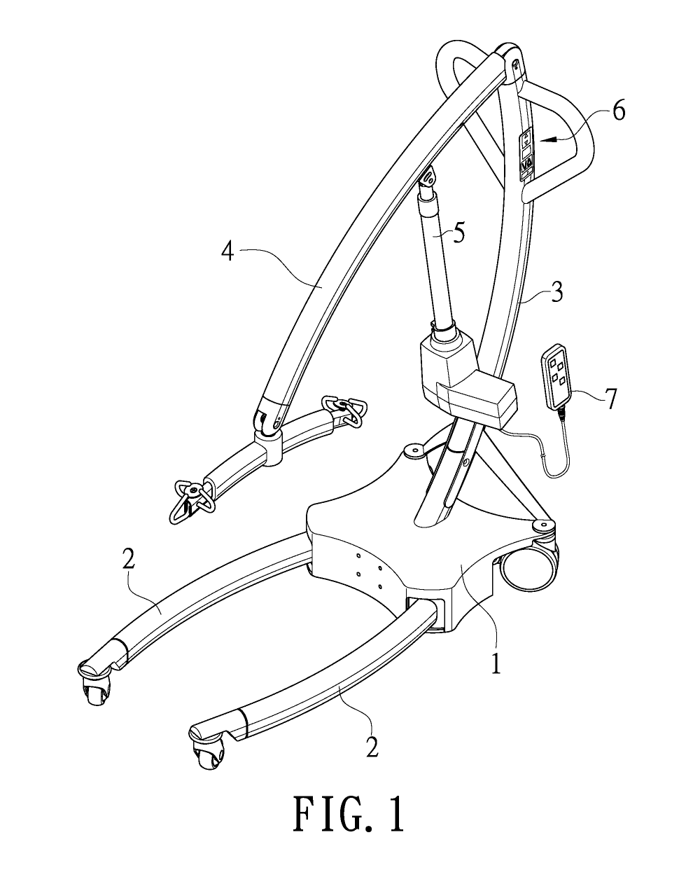

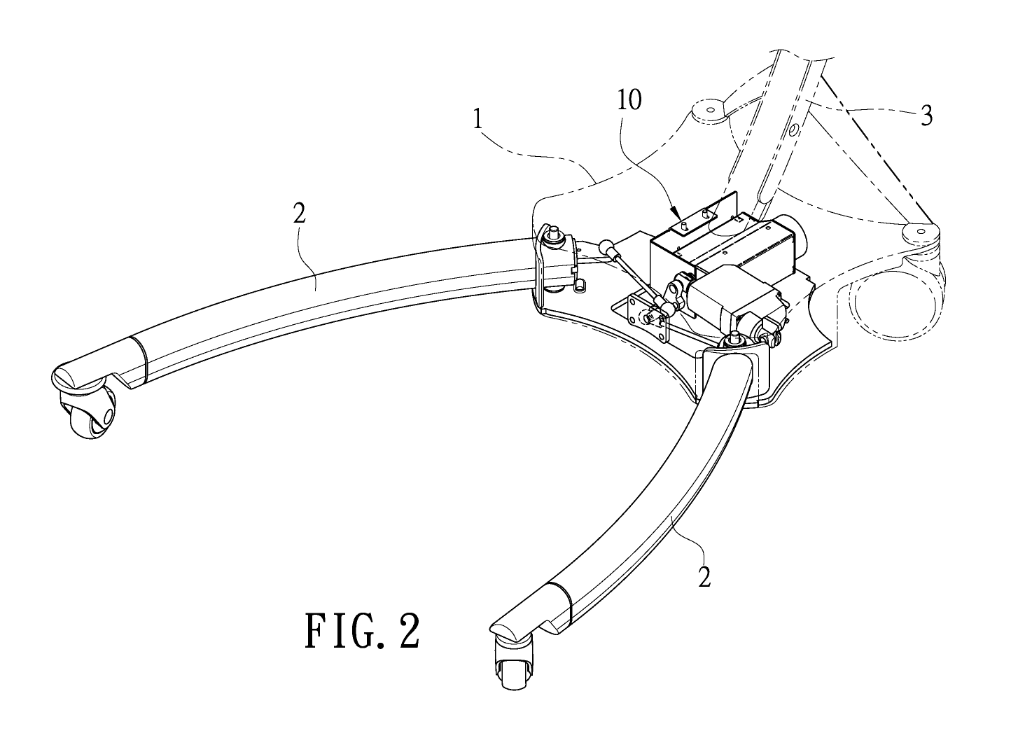

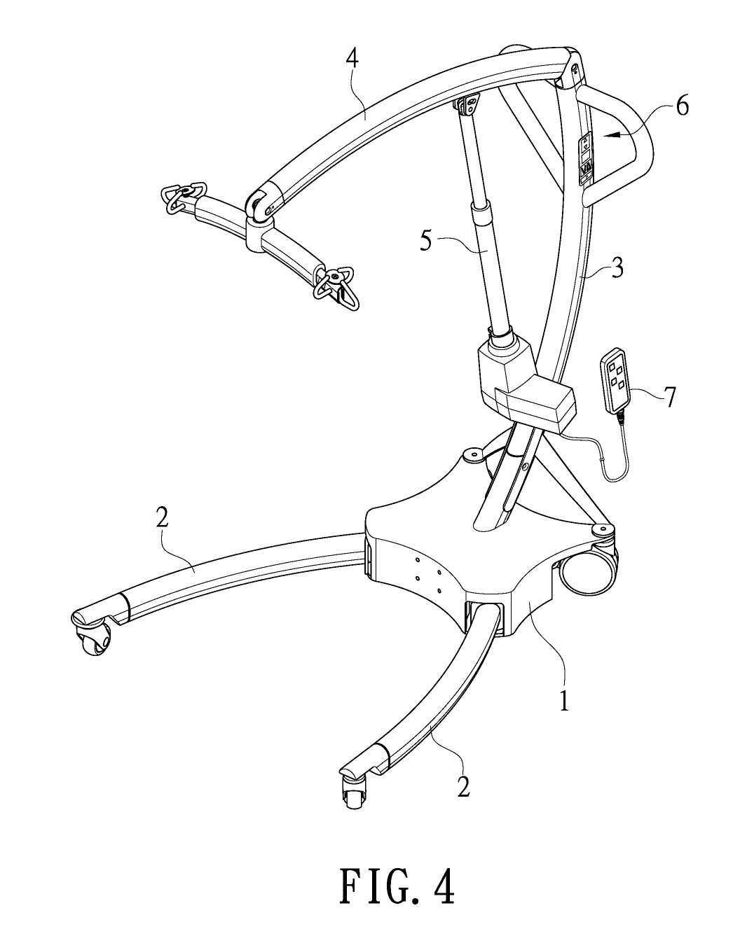

Referring to FIG. 1 to FIG. 4, a patient lift having automatic folding and unfolding apparatus of the present invention comprises a base (1) having a dynamic mechanism (10) in it, two supporting legs (2) connected to the dynamic mechanism (10), a main frame (3) disposed on the base (1), a lifting arm (4) pivotally connected to an end of the main frame (3), and a lifting device (5) disposed between the main frame (3) and the lifting arm (4). The dynamic mechanism (10) drives the two supporting legs (2) to spread and close.

The patient lift of the present invention is provided with an automatic controlling module (6) which is correspondingly connected to the dynamic mechanism (10) and the lifting device (5). The automatic controlling module (6) comprises an initiation unit (61) to initiate the dynamic mechanism (10) for spreading the two supporting legs (2) and the lifting device (5) for uplifting the lifting arm (4).

In addition to the initiation unit (61), the automatic controlling module (6) further comprises a first micro-switch unit (62) and a second micro-switch unit (63). The first micro-switch unit (62) controls the lifting device (5) to uplift or lower the lifting arm (4). The second micro-switch unit (63) controls the dynamic mechanism (10) to spread or close the two supporting legs (2). The automatic controlling module (6) further comprises a reset unit (64) for initiating and controlling the dynamic mechanism (10) to foldably reset the two supporting legs (2) and the lifting device (5) to downwardly reset the lifting arm (4).

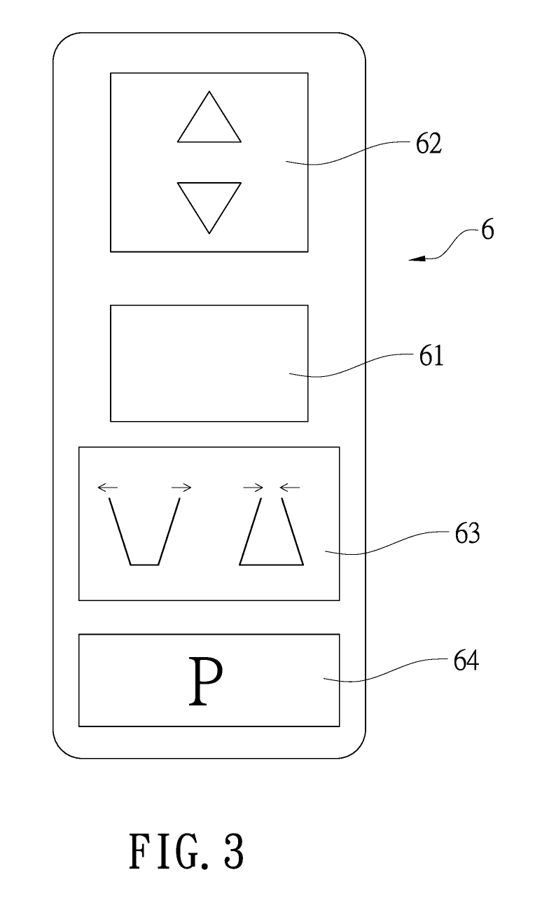

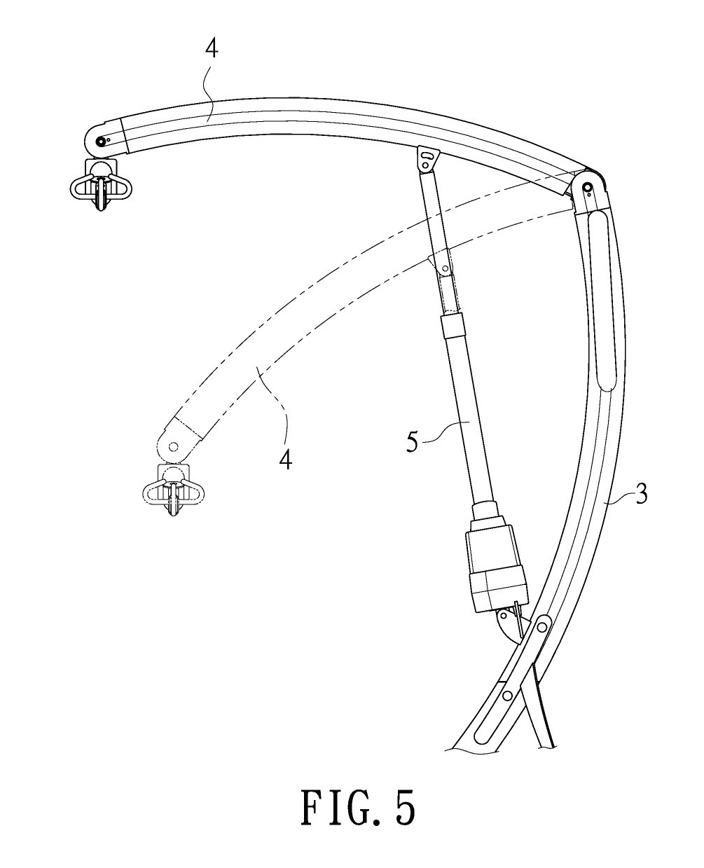

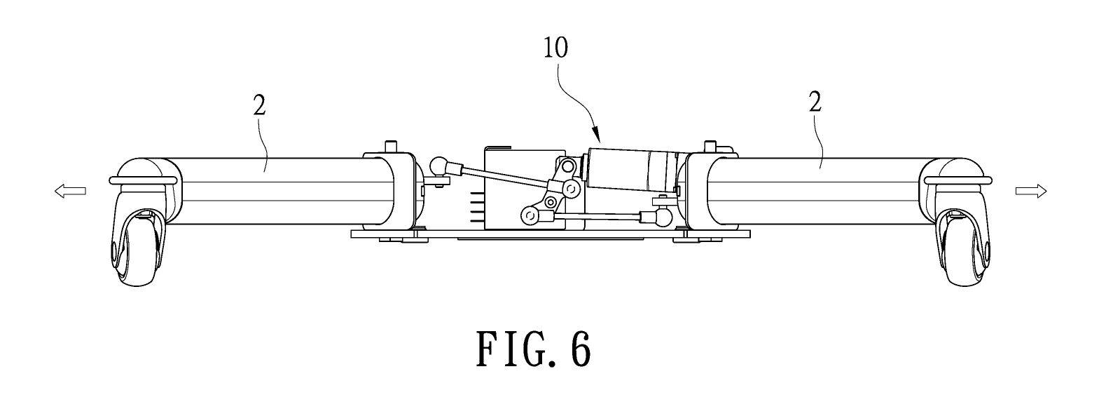

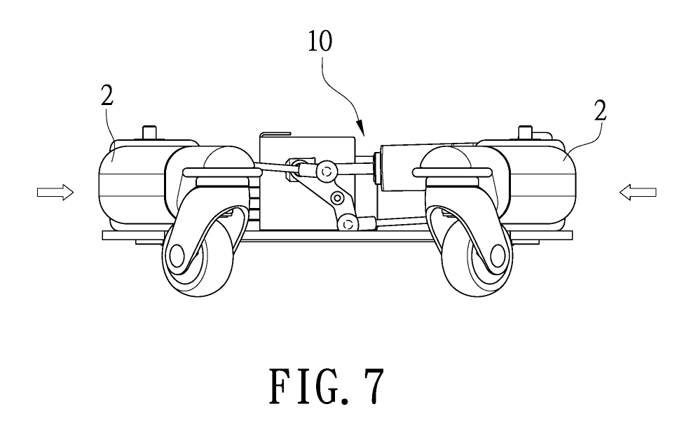

Referring to FIG. 1 to FIG. 7, in a practical use, the patient lift of the present invention is pushed to a hospital bed in a folded state for transporting a patient, and the automatic controlling module (6) is disposed on the main frame (3) or a place can be operated conveniently. Referring to FIG. 3 to FIG. 5, the initiation unit (61) of the automatic controlling module (6) is pressed to initiate the dynamic mechanism (10) and the lifting device (5). The dynamic mechanism (10) drives the two supporting legs (2) to spread to an appropriate angle which is adjustable, and the lifting device (5) uplifts or lowers the lifting arm (4) to an appropriate height which is also adjustable. The order to drive the supporting legs (2) and the lifting arm (4) are not limited. If the patient lift of the present invention is stable, the supporting legs (2) and the lifting arm (4) can be driven at the same time.

After the patient lift is placed near the hospital bed, the two supporting legs (2) are driven to embed under the hospital bed. If an expanding angel of the two supporting legs (2) is too large or too small, the two supporting legs (2) may unsuccessfully embed under the hospital bed and the central of the patient lift is prone to unstable. In such a case, a required expanding angel of the two supporting legs (2) can be adjusted gradually by pressing the second micro-switch unit (63). When the lifting arm (4) is uplifted to an inappropriate height, the first micro-switch unit (62) is pressed to gradually regulate the height of the lifting arm (4) for hanging a patient to be transported.

After transportation, the reset unit (64) is pressed for initiating the dynamic mechanism (10) to foldably reset the two supporting legs (2) and controlling the lifting device (5) to downwardly reset the lifting arm (4). The two supporting legs (2) and the lifting arm (4) are restituted to their original position for storage.

In consideration of spaces of hospitals or wards, the patient lift of the prevent invention is provided with an external remote controlling module (7), and the remote controlling module (7) is connected to the dynamic mechanism (10) and the lifting device (5) in a wired or a wireless manner. The remote controlling module (7) connectibly controls the dynamic mechanism (10) and the lifting device (5) to spread or close the two supporting legs (2) and to uplift or lower the lifting arm (4) respectively. The remote controlling module (7) can also be used to regulate the micro-switches.

According to the embodiments, the present invention, compared to the current techniques, has advantages as below:

1. The patient lift having automatic folding and unfolding apparatus of the present invention is controlled automatically, and medical staffs can operate the patient lift automatically without consuming labor for pedaling, so the present invention is convenient in use and has effects of time-saving and labor-saving.

2. The patient lift having automatic folding and unfolding apparatus of the present invention can be regulated gradually by micro-switches, and can be applied for transporting patients with different height and body weight, so the present invention is convenient and stably in use.

What is claimed is:

1. A patient lift having automatic folding and unfolding apparatus, comprising:
a base having a dynamic mechanism therein;
two supporting legs connected to and driven by the dynamic mechanism for spreading and closing actions;
a main frame disposed on the base;
a lifting arm pivotally connected to an end of the main frame;
a lifting device disposed between the main frame and the lifting arm; and
an automatic controlling module correspondingly connected to the dynamic mechanism and the lifting device, and comprising an initiation unit to initiate the dynamic mechanism for spreading the two supporting legs and uplifting the lifting arm.

2. As the patient lift having automatic folding and unfolding apparatus claimed in claim 1, wherein the automatic controlling module comprises a first micro-switch unit for controlling the lifting device to uplift or lower the lifting arm.

3. As the patient lift having automatic folding and unfolding apparatus claimed in claim 2, wherein the automatic controlling module comprises a second micro-switch unit for controlling the dynamic mechanism to spread or close the two supporting legs.

4. As the patient lift having automatic folding and unfolding apparatus claimed in claim 3, wherein the automatic controlling module comprises a reset unit for initiating and controlling the dynamic mechanism to foldably reset the two supporting legs and downwardly reset the lifting arm.

5. As the patient lift having automatic folding and unfolding apparatus claimed in claim 1, wherein the automatic controlling module is disposed on the main frame.

6. As the patient lift having automatic folding and unfolding apparatus claimed in claim 1, wherein the patient lift further comprises an external remote controlling module for connectibly controlling the dynamic mechanism and the lifting device to spread or close the two supporting legs and to uplift or lower the lifting arm.

7. As the patient lift having automatic folding and unfolding apparatus claimed in claim 6, wherein the remote controlling module connectibly controls the dynamic mechanism and the lifting device in a wired or a wireless manner.

8. As the patient lift having automatic folding and unfolding apparatus claimed in claim 4, wherein the automatic controlling module is disposed on the main frame.

9. As the patient lift having automatic folding and unfolding apparatus claimed in claim 4, wherein the patient lift further comprises an external remote controlling module for connectibly controlling the dynamic mechanism and the lifting device to spread or close the two supporting legs and to uplift or lower the lifting arm.

10. As the patient lift having automatic folding and unfolding apparatus claimed in claim 9, wherein the remote controlling module connectibly controls the dynamic mechanism and the lifting device in a wired or a wireless manner.
